(19) United States
(12) Patent Application Publication
(10) Pub. No.: US 2006/0282247 A1
(43) Pub. Date: Dec. 14, 2006

(54) Combined hardware and network simulator for testing embedded wireless communication device software and methods

(76) Inventors: James T. Brennan, Urbana, IL (US); Christopher A. Beyler, Urbana, IL (US); Kenneth A. Keller, Urbana, IL (US); David J. Krause, Kenosha, WI (US); Paul R. Poulosky, Urbana, IL (US)

Correspondence Address: MOTOROLA INC, 600 NORTH US HIGHWAY 45, ROOM AS437, LIBERTYVILLE, IL, 60048-5343, US

(21) Appl. No.: 11/136,986

(22) Filed: May 25, 2005

(51) Int. Cl. G06F 17/50

(52) U.S. Cl. 703/13

(57) ABSTRACT

A simulator and methods for evaluating embedded wireless communication software (110) including a wireless communication device hardware simulator on which the software is to be embedded and a radio frequency environment simulator (150), wherein the software is compiled (120) for actual wireless communication device hardware (140) in which the software is to be embedded before testing the compiled software on the simulated wireless communication device hardware in the simulated radio frequency environment.

### FIELD OF THE DISCLOSURE

The present disclosure relates generally to testing embedded wireless communication device software, and more particularly to testing such software on simulated wireless communication device hardware in a simulated radio frequency environment in which the wireless communication device operates, testing apparatuses and corresponding methods.

### BACKGROUND

Instruction set simulators and system level simulators are software development tools. An instruction set simulator (ISS) is a software program that simulates the behavior of a particular microprocessor, for example, an ARM processor from ARM, Ltd. An ISS is capable of running programs compiled into the binary format of the simulated microprocessor. The computer system upon which the ISS resides and executes is referred to as a host system. The ISS is a source program that is compiled into the binary format of the host system. The program that is loaded into the ISS must be in the binary format of the microprocessor which the ISS simulates. For example, an ISS that emulates the ARM processor can be compiled to run on INTEL x86 series processors. Similarly, a source program that is compiled into the binary format of the ARM processor can be loaded into the ISS and executed as it would on a real ARM processor. An exemplary ISS is the ARMULATOR available from ARM, Ltd.

While an instruction set simulator (ISS) simulates a microprocessor, a system level simulation (SLS) also simulates all or a subset of peripheral devices attached to the processor. In a computer system, for example, a software program running on the processor accesses peripheral devices, for instance, the program may read from, or write to, a hardware register in another device. External devices may also interact with the processor, for example, by generating an interrupt exception. Peripheral devices in an embedded system exemplary of a cellular phone include ROM/RAM, memory Control Registers, Interrupt Controller, Programmable Timer, Serial port, General Purpose Input/Output Controller, FLASH memory device, Keypad interface, LCD Display Driver, Watchdog Timer, Real Time Clock, Digital to Analog Converter, Analog to Digital Converter, Transmitter Control, and Receiver Control, among other devices. Other systems may include other types of peripherals. A system level simulation includes simulations of all of the peripheral devices that can be accessed by the software that runs on the ISS. Simulations of peripheral devices maintain state and respond to microprocessor accesses in the same way as the real device. Exemplary commercial system level simulators are available from VIRTIO and VIRTUTECH. Because system level simulators are capable of running the same binary image as actual hardware, a SLS is also referred to as “virtual hardware”. Since the processor is simulated by a software program, you can add features to it that allow one to examine any aspect of the simulated machine, stop at any point, control the flow of the program, produce software profiling information, examine and modify registers in peripheral devices, etc.

Another type of test environment, sometimes confused with instruction set simulators and system level simulators, are software emulators. The primary difference is that in a software emulation environment, the software program that is intended to be compiled for an embedded system is instead compiled to run on a host system. In addition, any part of the program that depends on the specifics of the embedded system is replaced with code that emulates the behavior of whatever it is replacing in the embedded system. Thus in a software emulation environment, the source code is modified and it is compiled to a different binary format, to run on a different system than the intended embedded system. An exemplary software emulation environment for testing Layers 2 & 3 of the W-CDMA Protocol Stack is the ANRITSU Virtual Signaling Test (VST) product. A software emulation environment has the disadvantage that it tests only a portion of the software for the system. Further, because the tested software is compiled for a different processor than the hardware on which the software will ultimately run, the software will behave differently during emulation than in the actual environment.

Wireless communication protocol software is typically qualified by testing a mobile terminal or device in a live network environment, by testing the mobile terminal using a hardware base station emulator, and by testing portions of the software protocol stack in software emulation environments.

The various aspects, features and advantages of the present disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary process flow diagram for testing embedded software compiled to run on a wireless communication device in either the real hardware or in a system level simulation environment which includes a simulation of the communication network.

FIG. 2 illustrates exemplary virtual network architecture for testing embedded software compiled to run on a wireless communication device.

FIG. 3 illustrates an exemplary system level simulation environment which includes a simulation of the communication network using internal simulation models or an external test program.

### DETAILED DESCRIPTION

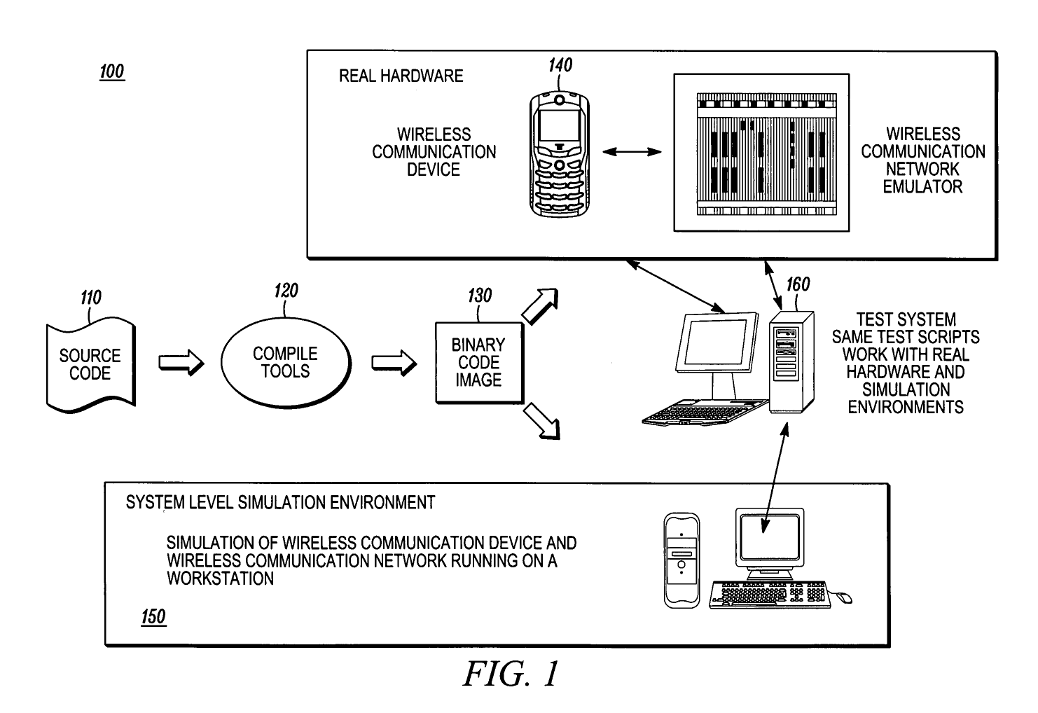

In the process diagram 100 in FIG. 1, source code 110 for a wireless communication device is compiled using a compiler tool 120 to produce a binary code image 130 for use in an actual communication device 140. Exemplary communications devices include, but are not limited to, CDMA, GSM, UMTS, AMPS and TDMA wireless communication devices. While the exemplary device 140 in FIG. 1 is a mobile communications handset or terminal, more generally, the communication device may be a fixed base transceiver station, for example, a UMTS Node b, or some other communication protocol compliant wireless station.

In one exemplary embodiment, the mobile device software is tested in a hardware simulator that includes a simulation of the cellular network. The simulated cellular network components are embedded within the simulation of the hardware. A programmable interface allows an external program to define characteristics of the simulated cellular network and the hardware simulation.

In FIG. 1, the binary code image 130, compiled for communication device 140 is tested in a simulated or virtual wireless communication network 150. Thus the simulation of the wireless communication device hardware on which the embedded software (binary code image 130) is compiled to run also includes simulation of the wireless network. The virtual network environment includes a simulation of the radio frequency environment in which the wireless communication device and particularly the embedded software operates. The radio frequency environment is simulated as it would appear from the perspective of the wireless communication device for which the software has been compiled. In embodiments where the virtual network environment is controlled by an external program, the program may be run on or by an external computer, for example, by computer 160 in FIG. 1, as discussed further below.

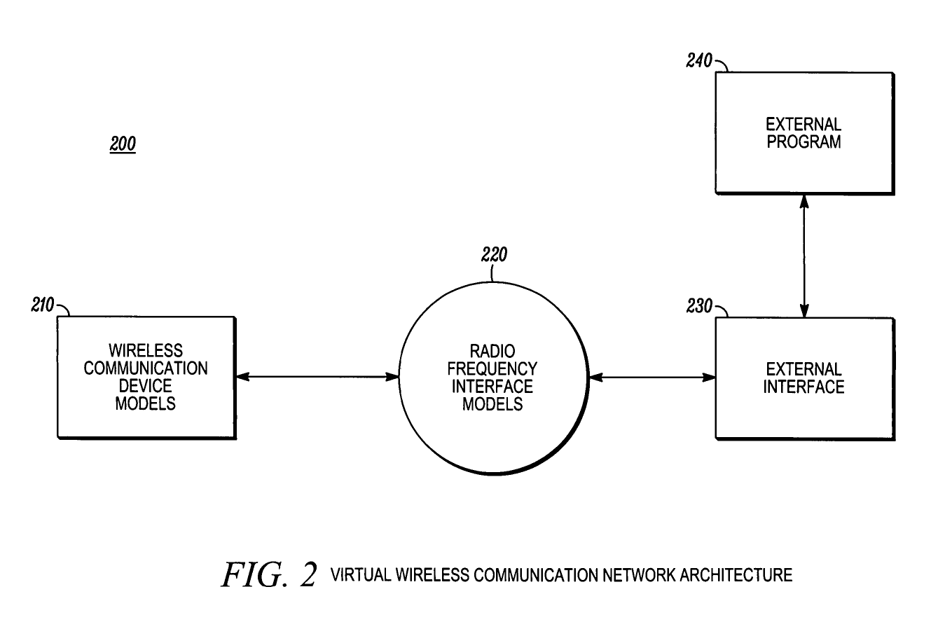

FIG. 2 is a high level block diagram of exemplary virtual wireless communication network 200 for testing embedded software compiled to run on a wireless communication device. The virtual network architecture comprises generally wireless communication device models 210 communicably coupled to a radio frequency interface 220. An external interface 230 is coupled to the radio frequency interface 220 to enable communication between the radio frequency interface and external programs 240, for example, an external test script run on the external computer 160 of FIG. 1.

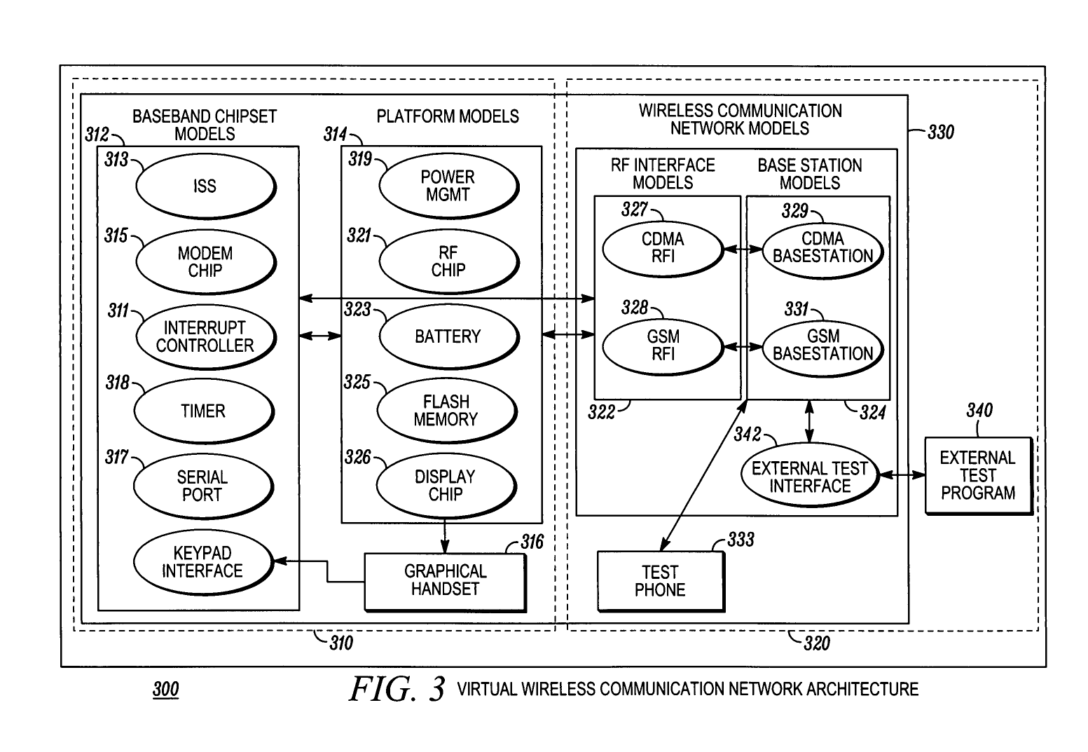

FIG. 3 is a more detailed illustration of an exemplary virtual wireless communication network system 300 comprising generally a wireless communication device simulator 310 and a wireless communication network simulator 320, both of which are included in a system level simulation environment 330. This environment permits testing embedded software compiled to run on an actual wireless communication device. The wireless communication device simulator 310 generally includes an instruction set simulator (ISS) model capable of running the same binary executable images, for example, image 130 in FIG. 1, compiled to run on an actual wireless communication device, for example, device 140 in FIG. 1.

Generally, the wireless communication device simulator also includes models for each functional block of the wireless communication device for which the embedded software is compiled. In FIG. 3, the wireless communication device simulator 310 comprises baseband chipset models 312, wireless protocol platform models 314, and graphical handset models 316. Exemplary baseband chipset models include an instruction set simulator (ISS) model 313, an analog and/or digital modem model 315, serial port models 317, a timer model 318, and an interrupt controller model 311. The exemplary platform 314 models include a power management model 319, an RF chip model 321, a battery model 323, a FLASH memory model 325, and a display model 326, all of which are communicably coupled to the one or more baseband chipset models 312.

Various features of the simulated wireless device hardware may be controlled during the simulation including transceiver tuning, power control, power measurement, encoder/decoder control, signal processing hardware, among others. Other functions that may be controlled by virtue of the simulation of the hardware and RF environment include physical radio frequency characteristics, such as frequency, power, timing, spreading codes, virtual network characteristics, such as access parameters, network id, system id, protocol revision, overhead information, and virtual network uplink and downlink channels including access channels, paging channels, broadcast channels, traffic channels, packet data channels. The simulation also allows an external programs or an internal base station to define all of the above characteristics, and then control the defined channels. These and all other aspects of the communication device hardware and radio frequency environment may be simulated.

In FIG. 3, the platform models 314 are communicably coupled with the baseband chipset models 312. Exemplary platform models 314 include, but are not limited to, power management, radio frequency chip models, battery, FLASH memory, and display chips described further below. Exemplary radio frequency chip models 321 include, but are not limited to, an RF tuning model, network power control models, network timer models, DSP models, etc. The radio frequency chip models are generally specific to a particular wireless communication protocol, for example, CDMA, GSM, UMTS, AMPS, TDMA, etc.

In FIG. 3, the wireless communication network simulator 320 includes at least a radio frequency interface (RFI) 322 communicably coupled to the wireless communication device simulator 310 and particularly to the baseband chipset models 312. Generally, the RFI objects are communicably coupled to multiple objects in device simulator 310. The RFI 322 simulates the radio frequency environment of the wireless communication device, and particularly that portion of the network interfaced by the embedded software. The RFI generally includes analog and/or digital radio frequency interface models communicably coupled to the corresponding modems of the wireless communication device simulator. In FIG. 3, the exemplary RFI 322 includes a CDMA RFI 327 and a GSM RFI 328 coupled to the baseband chipset models 312, including modem 315. Other RFI models specific to particular wireless communication protocols include, for example, TDMA, UMTS, AMPS and future generation protocols, supported by the wireless communication device.

The RFI models are also communicably coupled to base station models, which permit modeling base stations in the RF environment in which the embedded software is tested. In FIG. 3, the CDMA RFI 327 is communicably coupled to a CDMA base station model 329 and the GSM RFI 328 is communicably coupled to a GSM base station model 331. A test phone entity 333 is also included in the exemplary architecture for modeling another handset in the RF environment in which the embedded software is tested.

In one embodiment, embedded mobile wireless communication device software is tested by simulating the hardware and the radio frequency environment of a wireless communication device in which the software is to be embedded. The wireless communication device hardware and the radio frequency environment are simulated as they would appear to the embedded software when embedded on the actual mobile wireless communication device. The software to be tested is compiled as if it were to be installed on the actual wireless communication device hardware being simulated. The compiled software is then tested on the simulated wireless communication device hardware in the simulated radio frequency environment. In wireless communication applications, the wireless communication device software is typically tested for compliance with communications protocols and for performance under different network conditions.

In FIG. 3, the characteristics and behavior of the simulated wireless communication network is controlled from a programmable interface 342, for example, an application programming interface (API) socket, using an external program 340, for example, Java scripts. The same programs used to test the actual hardware may be used in the simulation environment.

In one embodiment, the simulated wireless communication network and the simulated hardware use a common time base. Timing information is communicated between the simulated wireless communication network and the external program at the programmable interface of the virtual wireless communication network. In FIG. 3, the external test interface model 342 provides time base information to the external program 340.

A common time base permits testing and analysis of the software at different or variable execution rates. By slowing the time base of the simulated hardware and network, for example, the software may be run at a rate slower than the software would run when installed on an actual phone. Thus when the simulation stops everything stops, including the radio frequency network. Execution of the software may also be stopped and stepped sequentially. This enables debugging of communication device software that manages the network and provides the ability to examine and modify the state of any device in the simulated system, which is not possible when testing on real hardware or on a hardware emulator. With actual hardware, it is not possible to stop or pause wireless radio transmissions.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. An embedded mobile wireless communication device software testing method, the method comprising:
simulating hardware of a wireless communication device in which the software is to be embedded;
simulating a radio frequency environment of the wireless communication device;
compiling the software for actual hardware of the wireless communication device in which the software is to be embedded;
testing the compiled software on the simulated wireless communication device hardware in the simulated radio frequency environment.

2. The method claim 1, simulating hardware and simulating the radio frequency environment includes simulating a wireless communication network as the wireless communication network appears to the embedded mobile wireless communication device software.

3. The method of claim 2, controlling the simulated wireless communication network from a programmable interface using an external program.

4. The method of claim 1, simulating the wireless communication network and simulating the hardware using a common time base.

5. The method of claim 4, providing simulated wireless communication network time base information to the external program at the programmable interface of the virtual wireless communication network.

6. The method of claim 5,
the embedded mobile wireless communication device software includes communication protocol software,
testing the communication protocol software network based on the time base information obtained by the external program.

7. A virtual wireless communication network simulation method for testing wireless communication device software, the method comprising:
simulating hardware of an actual wireless communication device;
simulating a radio frequency environment in which the actual wireless communication device operates;
testing software compiled for an actual wireless communication device in the simulated hardware and radio frequency environment of the virtual wireless communication network.

8. The method of claim 7, simulating hardware and simulating the radio frequency environment using a common time base.

9. The method of claim 7, controlling the simulated wireless communication network from a programmable interface using an external program.

10. The method of claim 7, the hardware and the radio frequency environment simulated in a common virtual wireless communication network

11. A wireless communication network simulator for testing embedded software compiled to run on an actual wireless communication device, the network simulator comprising:
a model for the actual wireless communication device for which the software is compiled;
a model for a radio frequency environment in which the actual wireless communication device operates;
a network environment simulator entity communicably coupled to the radio frequency models;
a programmable interface entity communicably coupled to the network environment simulator entity.

12. The network simulator of claim 11, the model for the actual wireless communication device and the models for the radio frequency environment in which the actual wireless communication device operates have a common time base.

13. The network simulator of claim 12, a test system for controlling the model for the actual wireless communication device and for controlling the model for the radio frequency environment.

14. The network simulator of claim 11, a programmable interface through which the simulated wireless communication network may be controlled using an external program.
